(19) United States
(12) Patent Application Publication
(10) Pub. No.: US 2023/0217347 A1
(43) Pub. Date: Jul. 6, 2023

(54) METHOD FOR URSP RULE-BASED APPLICATION DATA ROUTING, USER EQUIPMENT, AND STORAGE MEDIUM

(71) Applicant: BEIJING UNISOC COMMUNICATIONS TECHNOLOGY CO., LTD., Beijing (CN)

(72) Inventors: Zhiwei FU, Beijing (CN); Miao MIAO, Beijing (CN)

(21) Appl. No.: 18/007,526

(22) PCT Filed: Jul. 31, 2020
(86) PCT No.: PCT/CN2020/106335

§ 371 Date: Dec. 1, 2022

(30) Foreign Application Priority Data
Jun. 1, 2020 (CN) 202010486954.3

(51) Int. Cl. H04W 40/24; H04W 76/19

(52) U.S. Cl. CPC H04W 40/246; H04W 40/248; H04W 76/19

(57) ABSTRACT

A method for user equipment route selection policy (URSP) rule-based application data routing, user equipment (UE), and a storage medium are provided. The method includes: obtaining, by the UE, a list of URSP rules and a route selection descriptor (RSD) indication in the list of URSP rules, and establishing protocol data unit (PDU) sessions according to the RSD indication; obtaining, by the UE, traffic descriptor (TD) parameters in the URSP rules, and establishing a mapping between the TD parameters and the PDU sessions; and obtaining, by the UE, application data and a parameter corresponding to the application data, and determining a routing path of the application data according to the parameter and the mapping.

### TECHNICAL FIELD

The disclosure relates to the field of communication processing technology, and in particular, to a method for user equipment route selection policy (URSP) rule-based application data routing and user equipment (UE).

### BACKGROUND

In the 3rd generation partnership project (3GPP) protocol, the evaluation of user equipment route selection policies (URSP) requires the matching between a traffic descriptor (TD) parameter associated with an application and TD parameters in URSP rules. Then, a corresponding routing path is established for the application according to a route selection descriptor (RSD) in a successfully matched URSP rule. How to select a routing path for application data is not clearly agreed in the protocol at present.

### SUMMARY

Implementations of the disclosure disclose a method for user equipment route selection policy (URSP) rule-based application data routing and user equipment (UE), to select a routing path for application data and improve the user experience.

In a first aspect, implementations of the disclosure disclose a method for URSP rule-based application data routing. The method is applicable to a UE and includes: obtaining, by the UE, a list of URSP rules and a route selection descriptor (RSD) indication in the list of URSP rules, and establishing protocol data unit (PDU) sessions according to the RSD indication; obtaining, by the UE, traffic descriptor (TD) parameters in the URSP rules, and establishing a mapping between the TD parameters and the PDU sessions; and obtaining, by the UE, application data and a parameter corresponding to the application data, and determining a routing path of the application data according to the parameter and the mapping.

In a second aspect, an apparatus for URSP rule-based application data routing is provided. The apparatus includes an obtaining unit and a processing unit. The obtaining unit is configured to obtain a list of URSP rules and an RSD indication in the list of URSP rules. The processing unit is configured to establish PDU sessions according to the RSD indication. The obtaining unit is further configured to obtain TD parameters in the URSP rules. The processing unit is further configured to: establish a mapping between the TD parameters and the PDU sessions; obtain application data and a parameter corresponding to the application data; and determine a routing path of the application data according to the parameter and the mapping.

In a third aspect, a terminal is provided. The terminal includes a processor, a memory configured to store one or more programs, and a communication interface. The one or more programs are configured to be executed by the processor and include instructions for performing steps in the method of the first aspect.

In a fourth aspect, implementations of the disclosure disclose a computer-readable storage medium storing computer programs for electronic data interchange. The computer programs are operable with a computer to perform the method of the first aspect.

In a fifth aspect, implementations of the disclosure disclose a computer program product. The computer program product includes a non-transitory computer-readable storage medium storing computer programs. The computer programs are operable with a computer to perform some or all of steps described in the first aspect in implementations of the disclosure. The computer program product may be a software installation package.

With implementations of the disclosure, in technical solutions provided in the disclosure, the UE obtains the list of URSP rules and the RSD indication in the list of URSP rules. The UE establishes the PDU sessions according to the RSD indication, and then obtains the TD parameters in the URSP rules, and establishes the mapping between the TD parameters and the PDU sessions. In this way, when the UE has application data, the UE can obtain a parameter (i.e., a TD parameter) corresponding to the application data, and then obtain a PDU session corresponding to the parameter according to the parameter and the mapping, so as to determine the PDU session as the routing path of the application data. With the technical solutions, the routing path may be more suitable for the application data, thereby realizing the matching between the application data and the routing path and improving the user experience.

### BRIEF DESCRIPTION OF THE DRAWINGS

The drawings used in implementations of the disclosure are described below.

FIG. 1A is a system architecture diagram illustrating an example communication system provided in implementations of the disclosure.

FIG. 1B is a schematic structural diagram of a terminal provided in implementations of the disclosure.

FIG. 2 is a schematic flowchart of a method for user equipment route selection policy (URSP) rule-based application data routing provided in implementations of the disclosure.

FIG. 3 is a schematic structural diagram of an apparatus for URSP rule-based application data routing provided in implementations of the disclosure.

FIG. 4 is a schematic structural diagram of a device provided in implementations of the disclosure.

### DETAILED DESCRIPTION

Implementations of the disclosure will be described below with reference to the drawings in implementations of the disclosure.

The term “and/or” herein describes only an association relationship for describing associated objects and represents that three relationships may exist. For example, A and/or B may represent the following three cases: only A exists, both A and B exist, and only B exists. In addition, the character “/” herein indicates an “or” relationship between the associated objects.

In implementations of the disclosure, “a plurality of” refers to two or more. Descriptions such as “first” and “second” in implementations of the disclosure are merely used for indicating and distinguishing between described objects, do not show a sequence, do not indicate a specific limitation on a quantity of devices in implementations of the disclosure. In implementations of the disclosure, “connection” means various connection manners such as a direct connection or an indirect connection, for implementing communication between devices, which is not limited herein.

The application (APP) refers to various applications, such as a video application, a browser application, and the like installed on a device.

The protocol data unit (PDU) refers to a data unit transferred between peer layers. The PDU of the physical layer is a data bit, the PDU of the data link layer is a data frame, the PDU of the network layer is a data packet, the PDU of the transport layer is a data segment, and the PDU of another higher layer is data.

The PDU session is a granularity unit of the network slice in the fifth-generation (5G) mobile communication system.

Network slicing is an on-demand networking method, which can separate multiple virtual end-to-end networks from a unified infrastructure. Each network slice is logically isolated on a RAN, a bearer network, and a core network (CN) to adapt to various applications. A network slice can be divided into at least three parts: a wireless network sub-slice, a bearer network sub-slice, and a core network sub-slice.

A user equipment route selection policy (URSP) is policy information provided by the 5G core network (5GC) from a policy control function (PCF) to a UE. The UE determines how to route data to an outgoing path according to the URSP. According to URSP rules, the UE can determine whether a detected application can be associated with an established PDU session, whether data of the application can be routed to a non-3GPP path other than the PDU session, or whether a new PDU session can be established. Important input data in the URSP rule is parameters in traffic descriptors (TD), and the application can carry these parameters when initiating a network request. After an operating system (OS) obtains the TD parameter associated with the application and the UE obtains a list of URSP rules from the network, a matched route selection descriptor (RSD) is obtained according to the evaluation of the URSP rules, and then data routing is selected according to a routing path indicated by the RSD parameter.

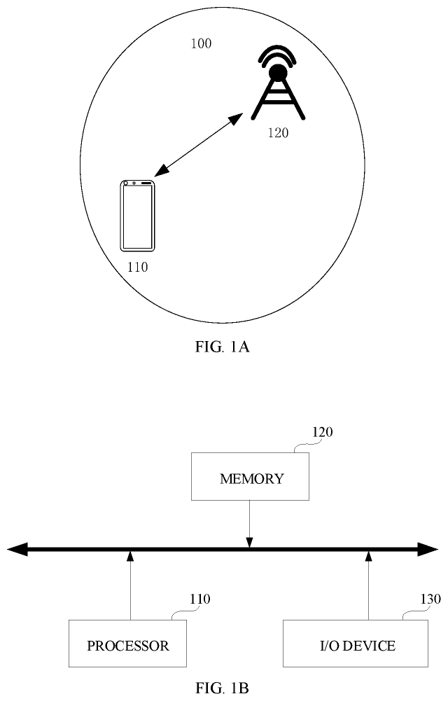

Technical solutions of implementations of the disclosure are applicable to an example communication system 100 illustrated in FIG. 1A. The example communication system 100 includes a terminal 110 and a network device 120. The terminal 110 is communicatively connected to the network device 120.

The example communication system 100 may be, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of the NR system, an LTE-based access to unlicensed spectrum (LTE-U) system, an NR-based access to unlicensed spectrum (NR-U) system, a universal mobile telecommunication system (UMTS), a next-generation communication system, or other communication systems.

Generally speaking, a conventional communication system generally supports a limited number of connections and therefore is easy to implement. However, with development of communication technology, a mobile communication system will not only support conventional communication but also support, for example, device to device (D2D) communication, machine to machine (M2M) communication, machine type communication (MTC), and vehicle to vehicle (V2V) communication. Implementations of the disclosure can also be applied to these communication systems.

Optionally, a communication system of implementations of the disclosure may be applied to a carrier aggregation (CA) scenario, a dual connectivity (DC) scenario, or a standalone (SA) network deployment scenario.

A spectrum applied is not limited in implementations of the disclosure. For example, implementations of the disclosure may be applicable to a licensed spectrum, and may also be applicable to an unlicensed spectrum.

The terminal 110 of implementations of the disclosure may refer to a UE, an access terminal, a subscriber unit, a subscriber station, a mobile station, a remote station, a remote terminal, a mobile device, a user terminal, a terminal, a wireless communication device, a user agent, or a user device. The terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, a relay device, an in-vehicle device, a wearable device, a terminal in a 5G network, a terminal in a future evolved public land mobile network (PLMN), or the like, which is not limited herein. As illustrated in FIG. 1B, the terminal 110 in implementations of the disclosure may include one or more of: a processor 110, a memory 120, and an input/output (I/O) device 130. The processor 110 is communicatively connected with the memory 120 and the I/O device 130 respectively.

The network device 120 of implementations of the disclosure may be a device that communicates with the terminal. The network device may be an evolved Node B (eNB or eNodeB) in the LTE system, or may be a radio controller in a cloud radio access network (CRAN). Alternatively, the network device may be a relay device, an access point, an in-vehicle device, a wearable device, a network device in the 5G network, or a network device in a future evolved PLMN, an antenna panel or a group of antenna panels (including multiple antenna panels) of a base station in the 5G system, or may be a network node forming a gNB or a transmission point, such as a baseband unit (BBU) or a distributed unit (DU), which is not limited herein.

In some deployments, the gNB may include a centralized unit (CU) and a DU. The gNB may further include an active antenna unit (AAU). The CU implements some functions of the gNB, and the DU implements some other functions of the gNB. For example, the CU is responsible for processing non-real-time protocols and services, and implements functions of a radio resource control (RRC) layer and functions of a packet data convergence protocol (PDCP) layer. The DU is responsible for processing physical (PHY) layer protocols and real-time services, and implements functions of a radio link control (RLC) layer, functions of a media access control (MAC) layer, and functions of a PHY layer. AAU implements some PHY layer processing functions, radio frequency processing functions, and active-antenna related functions. Since RRC layer information will eventually become PHY layer information, or is transformed from PHY layer information, in this architecture, it may be considered that higher layer signaling, such as RRC layer signaling, is transmitted by the DU, or transmitted by the DU and the AAU. It can be understood that, the network device may be a device including one or more of a CU node, a DU node, and an AAU node. In addition, the CU may be categorized as a network device in a radio access network (RAN), or may be categorized as a network device in a core network (CN), which is not limited herein.

In implementations of the disclosure, the terminal 110 or the network device 120 includes a hardware layer, an operating system layer running above the hardware layer, and an application layer running above the operating system layer. The hardware layer includes hardware such as a central processing unit (CPU), a memory management unit (MMU), and a memory (also referred to as main memory). The operating system may be any one or more computer operating systems that achieve service processing through a process, for example, a Linux operating system, a Unix operating system, an Android operating system, an iOS operating system, or a Windows operating system. The application layer includes applications such as a browser, a contact list, word processing software, and instant messaging (IM) software. In addition, implementations of the disclosure do not constitute limitation on the structure of an execution entity of a method provided in implementations, as long as the execution entity can communicate according to the method provided herein by running programs that record codes of the method. For example, the execution entity of the method may be the terminal, or may be a functional module in the terminal that can invoke and execute programs.

At present, in the 3rd generation partnership project (3GPP) protocol, the evaluation of URSP requires the matching between a TD parameter associated with an application and TD parameters in URSP rules. Then, a corresponding routing path is established for the application according to an RSD in a successfully matched URSP rule. How to select a routing path for the application is not clearly agreed in the protocol at present.

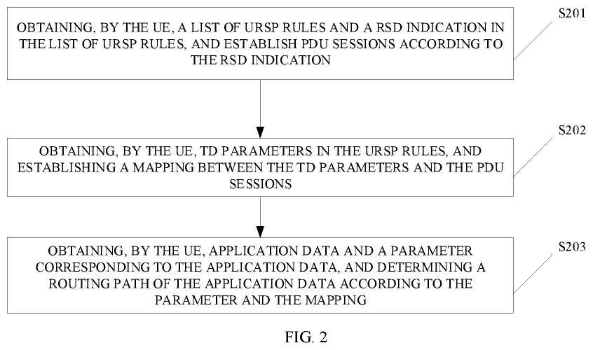

Referring to FIG. 2, FIG. 2 illustrates a method for URSP rule-based application data routing. The method is implemented under a network architecture illustrated in FIG. 1A. The method illustrated in FIG. 2 can be performed by the terminal illustrated in FIG. 1B. As illustrated in FIG. 2, the method includes the following.

At S201, a UE obtains a list of URSP rules and an RSD indication in the list of URSP rules, and establishes PDU sessions according to the RSD indication.

In an optional solution, the RSD indication in the list of URSP rules may include multiple RSD indications, or may be one RSD indication, and the number of the RSD indications is not limited herein. The method for establishing the PDU sessions according to the RSD indication may refer to the protocol specification.

At S202, the UE obtains TD parameters in the URSP rules, and establishes a mapping between the TD parameters and the PDU sessions.

In an optional solution, the TD parameters include one or any combination of: one or more application identifiers (APP ID), one or more internet protocol (IP) descriptors, one or more non-IP descriptors, one or more data network names (DNN), one or more connection capabilities, one or more domain descriptors, and one or more RSDs.

At S203, the UE obtains application data and a parameter corresponding to the application data, and determines a routing path of the application data according to the parameter and the mapping.

In an optional solution, the parameter corresponding to the application data may specifically be a TD parameter corresponding to the application data. It should be noted that, the type of the TD parameter corresponding to the application data needs to be the same as the type of the TD parameter in the mapping. For example, in an optional implementation, the TD parameter may be a DDN, the mapping is established between DDNs and PDU sessions, and the UE may obtain a DDN corresponding to the application data. In this way, PDU session 1 can be specifically found according to the DDN and the mapping, so as to determine PDU session 1 as the routing path of the application data. For another example, in another optional implementation, the TD parameter may also be an APP ID and connection capabilities, the mapping may be established between APP IDs, connection capabilities (that is, APP ID+connection capabilities), and PDU sessions, and the UE may obtain an APP ID and connection capabilities corresponding to the application data. In this way, PDU session 2 can be specifically found according to the APP ID, the connection capabilities (that is, APP ID+connection capabilities), and the mapping, so as to determine PDU session 2 as the routing path of the application data.

In technical solutions provided in the disclosure, the UE obtains the list of URSP rules and the RSD indication in the list of URSP rules. The UE establishes the PDU sessions according to the RSD indication, and then obtains the TD parameters in the URSP rules, and establishes the mapping between the TD parameters and the PDU sessions. In this way, when the UE has application data, the UE can obtain a parameter (i.e., a TD parameter) corresponding to the application data, and then obtain a PDU session corresponding to the parameter according to the parameter and the mapping, so as to determine the PDU session as the routing path of the application data. With the technical solutions, the routing path may be more suitable for the application data, thereby realizing the matching between the application data and the routing path and improving the user experience.

In an optional technical solution, determining the routing path of the application data according to the parameter and the mapping specifically includes: determining, by the UE, a first PDU session corresponding to the parameter by querying the mapping according to the parameter, and determining the first PDU session as the routing path of the application data.

In an optional technical solution, the method further includes: if the URSP rules are updated, new PDU sessions are re-established by the UE according to the updated URSP rules, establishing a new mapping between the new PDU sessions and TD parameters in the updated URSP rules.

There are many ways to update the URSP rules. For example, in an optional implementation, the URSP rules will be updated if the operator of the network is changed. In practical applications, the URSP rules may be updated after the OS of the UE is upgraded or in various other technical scenarios.

In a specific implementation, obtaining, by the UE, the TD parameters in the URSP rules, and establishing the mapping between the TD parameters and the PDU sessions specifically includes: establishing, by the UE, a mapping between APP IDs, IP descriptors, and the PDU sessions on condition that the TD parameters in the URSP rules include the APP IDs and the IP descriptors.

In another specific implementation, obtaining, by the UE, the TD parameters in the URSP rules, and establishing the mapping between the TD parameters and the PDU sessions specifically includes: establishing, by the UE, a mapping between APP IDs and the PDU sessions on condition that the TD parameters in the URSP rules include the APP IDs.

In another specific implementation, obtaining, by the UE, the TD parameters in the URSP rules, and establishing the mapping between the TD parameters and the PDU sessions specifically includes: establishing, by the UE, a mapping between IP descriptors and the PDU sessions on condition that the TD parameters in the URSP rules include the IP descriptors.

In another specific implementation, obtaining, by the UE, the TD parameters in the URSP rules, and establishing the mapping between the TD parameters and the PDU sessions specifically includes: establishing, by the UE, a mapping between APP IDs, connection capabilities, and the PDU sessions on condition that the TD parameters in the URSP rules include the APP IDs and the connection capabilities.

In an optional implementation, obtaining, by the UE, the TD parameters in the URSP rules, and establishing the mapping between the TD parameters and the PDU sessions specifically includes: establishing, by the UE, a mapping between APP IDs, fully qualified domain names (FQDN), and the PDU sessions on condition that the TD parameters in the URSP rules include the APP IDs and the FQDNs.

In the technical solutions above, a correspondence (i.e., a mapping) is established between parameters, i.e., APP IDs, IP descriptors, domain descriptors, DNNs, and connection capabilities specified by the TD parameters (which are taken as network interface attributes) and the PDU sessions. When an application initiates a data service (i.e., application data), the OS obtains the feature attribute of the application data, such as the APP ID corresponding to the application data. A destination IP address or FQDN information of the application data are contained in the established correspondence (i.e., the mapping). Then, the application data can be routed through a specified PDU session. In the disclosure, the application data can be routed through a designated path or access a designated network slice (i.e., a corresponding PDU session) without changing an interface between the application and the OS, thereby realizing the matching between the application data the and network slice and improving the user experience.

Implementation 1

Implementation 1 of the disclosure provides a method for URSP rule-based application data routing. The method may specifically include the following. The UE obtains a URSP rule, where the URSP rule includes parameters, i.e., a DNN and connection capabilities. The UE establishes PDU session 1 according to an RSD indication included in the URSP rule. Then, the OS first establishes the PDU session according to the RSD indication in the URSP rule, and then creates a mapping between the parameters, i.e., the DNN and the connection capabilities (that is, DNN+connection capabilities) in the URSP rule and the PDU session. When an application of the UE initiates a data service request with corresponding parameters, application data of the data service request can be routed according to the previously created mapping. Specifically, the application can initiate the data service request with the corresponding parameters, so as to obtain the correspondence between the two TD parameters, i.e., the DNN and the connection capabilities and the PDU session.

Implementation 2

Implementation 2 of the disclosure provides a method for URSP rule-based application data routing. The method may specifically include the following. The UE obtains a URSP rule, where the URSP rule includes parameters, i.e., an APP ID and an IP descriptor, or an APP ID and an FQDN. The UE establishes a PDU session according to an RSD indication included in the URSP rule. Then, the OS first establishes the PDU session according to the RSD indication in the URSP rule, and then establishes a mapping between the parameters, i.e., the APP ID and the IP descriptor (that is, APP ID+IP descriptor) or the APP ID and the FQDN (that is, APP ID+FQDN) in the URSP rule and the PDU session. If the APP ID of an application matches the APP ID and the data of the application needs to be routed to a destination address indicated by the IP descriptor or the FQDN parameter, the data can be routed through the PDU session. The data of the specific application (APP ID) can be routed to the destination address indicated by the specified IP descriptor or FQDN parameter, so as to obtain the mapping between the three TD parameters and the PDU session.

Implementation 3

Implementation 3 of the disclosure provides a method for URSP rule-based application data routing. The method may specifically include the following. The UE obtains a URSP rule, where the URSP rule only includes a parameter, i.e., an IP descriptor or an FQDN. The UE establishes a PDU session according to an RSD indication in the URSP rule. Then, the OS establishes a mapping between the parameter, i.e., the IP descriptor or the FQDN in the URSP rule and the PDU session. All data routed to a destination address indicated by the IP descriptor or the FQDN parameter can be routed through the PDU session. The data can be routed to the destination address indicated by the specified IP descriptor or FQDN parameter, so as to obtain the correspondence between the two TD parameters and the PDU session.

Implementation 4

Implementation 4 of the disclosure provides a method for URSP rule-based application data routing. The method may specifically include the following. The UE obtains a URSP rule, where the URSP rule only includes a parameter, i.e., an APP ID. The UE establishes a PDU session according to an RSD indication in the URSP rule. Then, the OS first establishes the PDU session according to the RSD indication in the URSP rule, and then establishes a mapping between the parameter, i.e., the APP ID in the URSP rule and the PDU session. Only data of an application indicated by the APP ID can be routed through the PDU session.

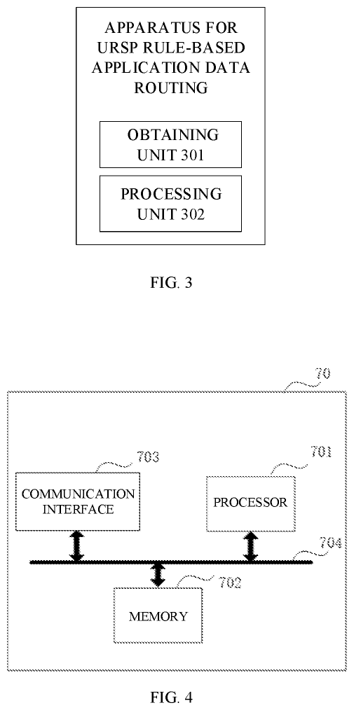

Referring to FIG. 3, FIG. 3 illustrates an apparatus for URSP rule-based application data routing. The apparatus can be set in a UE or a terminal. As illustrated in FIG. 3, the apparatus includes an obtaining unit 301 and a processing unit 302. The obtaining unit 301 is configured to obtain a list of URSP rules and an RSD indication in the list of URSP rules. The processing unit 302 is configured to establish PDU sessions according to the RSD indication. The obtaining unit 301 is further configured to obtain TD parameters in the URSP rules. The processing unit 302 is further configured to: establish a mapping between the TD parameters and the PDU sessions, obtain application data and a parameter corresponding to the application data, and determine a routing path of the application data according to the parameter and the mapping.

In technical solutions provided in the disclosure, the UE obtains the list of URSP rules and the RSD indication in the list of URSP rules. The UE establishes the PDU sessions according to the RSD indication, and then obtains the TD parameters in the URSP rules, and establishes the mapping between the TD parameters and the PDU sessions. In this way, when the UE has application data, the UE can obtain a parameter (i.e., a TD parameter) corresponding to the application data, and then obtain a PDU session corresponding to the parameter according to the parameter and the mapping, so as to determine the PDU session as the routing path of the application data. With the technical solutions, the routing path may be more suitable for the application data, thereby realizing the matching between the application data and the routing path and improving the user experience.

In an optional solution, the TD parameters include one or any combination of: one or more APP IDs, one or more IP descriptors, one or more non-IP descriptors, one or more DNNs, one or more connection capabilities, one or more domain descriptors, and one or more RSDs.

In an optional technical solution, the processing unit 302 is specifically configured to: determine a first PDU session corresponding to the parameter by querying the mapping according to the parameter, and determine the first PDU session as the routing path of the application data.

In an optional technical solution, the processing unit 302 is specifically configured to: on condition that the URSP rules are updated, new PDU sessions are re-established according to the updated URSP rules, establish a new mapping between the new PDU sessions and TD parameters in the updated URSP rules.

There are many ways to update the URSP rules. For example, in an optional implementation, the URSP rules will be updated if the operator of the network is changed. In practical applications, the URSP rules may be updated after the OS of the UE is upgraded or in various other technical scenarios.

In a specific implementation, in an optional technical solution, the processing unit 302 is specifically configured to: establish a mapping between APP IDs, IP descriptors, and the PDU sessions on condition that the TD parameters in the URSP rules include the APP IDs and the IP descriptors.

In another specific implementation, in an optional technical solution, the processing unit 302 is specifically configured to: establish a mapping between APP IDs and the PDU sessions on condition that the TD parameters in the URSP rules include the APP IDs.

In another specific implementation, in an optional technical solution, the processing unit 302 is specifically configured to: establish a mapping between IP descriptors and the PDU sessions on condition that the TD parameters in the URSP rules include the IP descriptors.

In another specific implementation, in an optional technical solution, the processing unit 302 is specifically configured to: establish a mapping between APP IDs, connection capabilities, and the PDU sessions on condition that the TD parameters in the URSP rules include the APP IDs and the connection capabilities.

In an optional implementation, in an optional technical solution, the processing unit 302 is specifically configured to: establish a mapping between APP IDs, FQDNs, and the PDU sessions on condition that the TD parameters in the URSP rules include the APP IDs and the FQDNs.

Referring to FIG. 4, FIG. 4 illustrates a device 70 (for example, a terminal) provided in implementations of the disclosure. The device 70 includes a processor 701, a memory 702, and a communication interface 703. The processor 701, the memory 702, and the communication interface 703 are connected to each other via a bus 704.

The memory 702 includes, but is not limited to, a random access memory (RAM), a read-only memory (ROM), an erasable programmable ROM (EPROM), or a compact disc ROM memory (CD-ROM). The memory 702 is configured to store related computer programs and data. The communication interface 703 is used to receive and transmit data.

The processor 701 may be one or more central processing units (CPU). In a case where the processor 701 is a CPU, the CPU may be a single-core CPU or a multi-core CPU.

The processor 701 in the device 70 is configured to read computer program codes stored in the memory 702 to: obtain a list of URSP rules and an RSD indication in the list of URSP rules, and establish PDU sessions according to the RSD indication, obtain TD parameters in the URSP rules, and establish a mapping between the TD parameters and the PDU sessions, and obtain application data and a parameter corresponding to the application data, and determine a routing path of the application data according to the parameter and the mapping.

All relevant contents of the scenarios involved in the above method implementations may be cited in function descriptions of corresponding functional modules, which will not be repeated herein. The apparatus for URSP rule-based application data routing of the application can perform steps performed by the UE in the apparatus for URSP rule-based application data routing illustrated in FIG. 2.

Implementations of the disclosure further provide a chip system. The chip system includes at least one processor, a memory, and an interface circuit. The memory, the transceiver, and the at least one processor are interconnected via lines. The at least one memory stores computer programs. The computer programs are executed by the processor to implement the method illustrated in FIG. 2.

Implementations of the disclosure further provide a computer-readable storage medium storing computer programs. The computer programs run on a network device to perform the method illustrated in FIG. 2.

Implementations of the disclosure further provides a computer program product. The computer program product runs on a terminal to perform the method illustrated in FIG. 2.

Implementations of the disclosure further provide a terminal. The terminal includes a processor, a memory configured to store one or more programs, and a communication interface. The one or more programs are configured to be executed by the processor and include instructions for performing steps in the method in implementations illustrated in FIG. 2.

The foregoing solution of the implementations of the disclosure is mainly described from the viewpoint of execution process of the method. It can be understood that, in order to implement the above functions, the electronic device includes hardware structures and/or software modules corresponding to the respective functions. Those skilled in the art should readily recognize that, in combination with the example units and scheme steps described in the implementations provided herein, the present disclosure can be implemented in hardware or a combination of the hardware and computer software. Whether a function is implemented by way of the hardware or hardware driven by the computer software depends on the particular application and design constraints of the technical solution. Those skilled in the art may use different methods to implement the described functions for each particular application, but such implementation should not be considered as beyond the scope of the present disclosure.

According to the implementations of the disclosure, functional units may be divided for the electronic device in accordance with the foregoing method examples. For example, each functional unit may be divided according to each function, and two or more functions may be integrated in one processing unit. The above-mentioned integrated unit can be implemented in the form of hardware or software functional units. It should be noted that the division of units in the implementations of the present disclosure is schematic, and is merely a logical function division, and there may be other division manners in actual implementation.

It should be noted that, for the sake of simplicity, the foregoing method implementations are described as a series of action combinations, however, it will be appreciated by those skilled in the art that the disclosure is not limited by the sequence of actions described. According to the disclosure, certain steps or operations may be performed in other order or simultaneously. Besides, it will be appreciated by those skilled in the art that the implementations described in the specification are exemplary implementations and the actions and modules involved are not necessarily essential to the disclosure.

In the foregoing implementations, the description of each implementation has its own emphasis. For the parts not described in detail in one implementation, reference may be made to related descriptions in other implementations.

In implementations provided in the disclosure, it should be understood that, the apparatus disclosed in implementations provided herein may be implemented in other manners. For example, the device/apparatus implementations described above are merely illustrative; for instance, the division of the unit is only a logical function division and there can be other manners of division during actual implementations, for example, multiple units or components may be combined or may be integrated into another system, or some features may be ignored, omitted, or not performed. In addition, coupling or communication connection between each illustrated or discussed component may be direct coupling or communication connection, or may be indirect coupling or communication among devices or units via some interfaces, and may be electrical connection, mechanical connection, or other forms of connection.

The units described as separate components may or may not be physically separated, the components illustrated as units may or may not be physical units, that is, they may be in the same place or may be distributed to multiple network elements. All or part of the units may be selected according to actual needs to achieve the purpose of the technical solutions of the implementations.

In addition, the functional units in various implementations of the disclosure may be integrated into one processing unit, or each unit may be physically present, or two or more units may be integrated into one unit. The above-mentioned integrated unit can be implemented in the form of hardware or a software function unit.

The integrated unit may be stored in a computer-readable memory when it is implemented in the form of a software functional unit and is sold or used as a separate product. Based on such understanding, the technical solutions of the disclosure essentially, or the part of the technical solutions that contributes to the related art, or all or part of the technical solutions, may be embodied in the form of a software product which is stored in a memory and includes instructions for causing a computer device (which may be a personal computer, a server, or a network device and so on) to perform all or part of the steps described in the various implementations of the disclosure. The memory includes various medium capable of storing program codes, such as a universal serial bus (USB) flash disk, a ROM, a RAM, a removable hard disk, disk, compact disc (CD), or the like.

It will be understood by those of ordinary skill in the art that all or a part of the various methods of the implementations described above may be accomplished by means of a program to instruct associated hardware, the program may be stored in a computer-readable memory, which may include a flash memory, a ROM, a RAM, disk or compact disc (CD), and so on.

Implementations of the disclosure are described in detail above, and specific examples are used herein to illustrate principles and implementations of the disclosure. The illustration of implementations above are only used to help understand the methods and core ideas of the disclosure. At the same time, for those of ordinary skill in the art, based on the ideas of the disclosure, there may be changes in the specific implementations and scope of the disclosure. In conclusion, the content of this specification should not be construed as a limitation to the disclosure.

1. A method for user equipment route selection policy (URSP) rule-based application data routing, being applicable to user equipment (UE) and comprising:
obtaining, by the UE, a list of URSP rules and a route selection descriptor (RSD) indication in the list of URSP rules, and establishing protocol data unit (PDU) sessions according to the RSD indication;
obtaining, by the UE, traffic descriptor (TD) parameters in the URSP rules, and establishing a mapping between the TD parameters and the PDU sessions; and
obtaining, by the UE, application data and a parameter corresponding to the application data, and determining a routing path of the application data according to the parameter and the mapping.

2. The method of claim 1, wherein determining the routing path of the application data according to the parameter and the mapping specifically comprises:
determining, by the UE, a first PDU session corresponding to the parameter by querying the mapping according to the parameter, and determining the first PDU session as the routing path of the application data.

3. The method of claim 1,
wherein the URSP rules are updated, and the method further comprises:
re-establishing new PDU sessions according to the updated URSP rules; and
establishing a new mapping between the new PDU sessions and TD parameters in the updated URSP rules.

4. The method of claim 1, wherein the TD parameters comprise one or any combination of:
one or more application identifiers (APP ID);
one or more internet protocol (IP) descriptors;
one or more non-IP descriptors;
one or more data network names (DNN);
one or more connection capabilities;
one or more domain descriptors; and
one or more RSDs.

5. The method of claim 1, wherein establishing the mapping between the TD parameters and the PDU sessions specifically comprises:
establishing, by the UE, a mapping between APP IDs, IP descriptors, and the PDU sessions, wherein the TD parameters in the URSP rules comprise the APP IDs and the IP descriptors.

6. The method of claim 1, wherein establishing the mapping between the TD parameters and the PDU sessions specifically comprises:
establishing, by the UE, a mapping between APP IDs and the PDU sessions, wherein the TD parameters in the URSP rules comprise the APP IDs.

7. The method of claim 1, wherein establishing the mapping between the TD parameters and the PDU sessions specifically comprises:
establishing, by the UE, a mapping between IP descriptors or fully qualified domain names (FQDN) and the PDU sessions, wherein the TD parameters in the URSP rules comprise the IP descriptors or the FQDNs.

8. The method of claim 1, wherein establishing the mapping between the TD parameters and the PDU sessions specifically comprises:
establishing, by the UE, a mapping between APP IDs, FQDNs, and the PDU sessions, wherein the TD parameters in the URSP rules comprise the APP IDs and the FQDNs.

9. A user equipment (UE) comprising:
a memory configured to store one or more programs; and
a processor configured to invoke and execute the one or more programs to:
obtain a list of URSP rules and a route selection descriptor (RSD) indication in the list of URSP rules, and
establish protocol data unit (PDU) sessions according to the RSD indication;
obtain traffic descriptor (TD) parameters in the URSP rules, and
establish a mapping between the TD parameters and the PDU sessions; and
obtain application data and a parameter corresponding to the application data, and
determine a routing path of the application data according to the parameter and the mapping.

10. The UE of claim 9, wherein the processor is specifically configured to:
determine a first PDU session corresponding to the parameter by querying the mapping according to the parameter, and determine the first PDU session as the routing path of the application data.

11. The UE of claim 9, wherein
the URSP rules are updated, and the processor is further configured to:
re-establish new PDU sessions according to the updated URSP rules; and
establish a new mapping between the new PDU sessions and TD parameters in the updated URSP rules.

12. The UE of claim 9, wherein the TD parameters comprise one or any combination of:
one or more application identifiers (APP ID);
one or more internet protocol (IP) descriptors;
one or more non-IP descriptors;
one or more data network names (DNN);
one or more connection capabilities;
one or more domain descriptors; and
one or more RSDs.

13. The UE of claim 9, wherein the processor is specifically configured to:
establish a mapping between APP IDs, IP descriptors, and the PDU sessions on condition that the TD parameters in the URSP rules comprise the APP IDs and the IP descriptors.

14. The UE of claim 9, wherein the processor is specifically configured to:
establish a mapping between APP IDs and the PDU sessions on condition that the TD parameters in the URSP rules comprise the APP IDs.

15. The UE of claim 9, wherein the processor is specifically configured to:
establish a mapping between IP descriptors or fully qualified domain names (FQDN) and the PDU sessions on condition that the TD parameters in the URSP rules comprise the IP descriptors or the FQDNs.

16. The UE of claim 9, wherein the processor is specifically configured to:
establish a mapping between APP IDs, FQDNs, and the PDU sessions on condition that the TD parameters in the URSP rules comprise the APP IDs and the FQDNs.

17. (canceled)

18. A non-transitory computer-readable storage medium storing computer programs which are operable with a processor to:
obtain a list of URSP rules and a route selection descriptor (RSD) indication in the list of URSP rules, and establish protocol data unit (PDU) sessions according to the RSD indication;
obtain traffic descriptor (TD) parameters in the URSP rules, and establish a mapping between the TD parameters and the PDU sessions; and
obtain application data and a parameter corresponding to the application data, and determine a routing path of the application data according to the parameter and the mapping.

19. (canceled)

20. The non-transitory computer-readable storage medium of claim 18, wherein the computer programs are specifically operable with the processor to:
determine a first PDU session corresponding to the parameter by querying the mapping according to the parameter, and determine the first PDU session as the routing path of the application data.

21. The non-transitory computer-readable storage medium of claim 18, wherein the URSP rules are updated, and the computer programs are further operable with the processor to:
re-establish new PDU sessions according to the updated URSP rules; and
establish a new mapping between the new PDU sessions and TD parameters in the updated URSP rules.

22. The non-transitory computer-readable storage medium of claim 18, wherein the TD parameters comprise one or any combination of:
one or more application identifiers (APP ID);
one or more internet protocol (IP) descriptors;
one or more non-IP descriptors;
one or more data network names (DNN);
one or more connection capabilities;
one or more domain descriptors; and
one or more RSDs.
